(19) United States
(12) Patent Application Publication
(10) Pub. No.: US 2024/0272191 A1
(43) Pub. Date: Aug. 15, 2024

(54) SYSTEMS AND METHODS FOR INTRODUCING SAMPLES TO OPEN PORT INTERFACE

(71) Applicants: DH Technologies Development Pte. Ltd., Singapore (SG); United States of America, as represented by the Secretary, Department of Health and Human Services, Bethesda, MD (US)

(72) Inventors: Meghav Verma, Germantown, MD (US); Samuel Michael, Germantown, MD (US); John Janiszewski, Westerly, RI (US); Chang Liu, Richmond Hill (CA); Thomas R. Covey, Newmarket (CA)

(73) Assignees: DH Technologies Development Pte. Ltd., Singapore (SG); United States of America, as represented by the Secretary, Department of Health and Human Services, Bethesda, MD (US)

(21) Appl. No.: 18/439,795

(22) Filed: Feb. 13, 2024

Related U.S. Application Data
(60) Provisional application No. 63/445,914, filed on Feb. 15, 2023.

(51) Int. Cl. G01N 35/10

(52) U.S. Cl. CPC G01N 35/1072; G01N 35/1011

(57) ABSTRACT

A method of processing a sample plate containing a plurality of samples includes aspirating simultaneously, from the sample plate, a first sample droplet from a first sample of the plurality of samples with a first pipette and a second sample droplet from a second sample of the plurality of samples with a second pipette. The sample plate also includes dispensing sequentially, from the first pipette and the second pipette, the first sample drop and the second sample drop into an open port interface (OPI).

### CROSS-REFERENCE TO RELATED APPLICATIONS

This application claims the benefit of priority to U.S. Provisional Application No. 63/445,914 filed Feb. 15, 2023, which application is hereby incorporated in its entirety by reference.

### BACKGROUND

A microplate (also referred to as a well tray, well plate, microtiter plate, microwell plate, multiwell, etc.) is a flat plate with multiple “wells” used as small test tubes. The microplate has become a standard tool in analytical research and clinical diagnostic testing laboratories. A well plate typically has 6, 12, 24, 48, 96, 384 or 1536 sample wells arranged, e.g., in a 2:3 rectangular matrix. Each well of a microplate typically holds between tens of nanolitres to several millilitres of liquid samples.

Open-port interface (OPI) is a universal interface connecting an electrospray ionization (ESI) or atmospheric pressure chemical ionization (APCI) source of mass spectrometry (MS) with various formats of samples. It separates the sampling events from the ionization process, so that the benefits of both ambient ionization such as high-throughput, less sample preparation, and the advantages of ESI/APCI, including the high sensitivity, reproductivity and wide compound coverage, could be achieved simultaneously. The use of OPI to capture a nanoliter sized sample droplets has demonstrated some unique benefits including the high analytical throughput (signal peak could be less than a second wide), and the high matrix tolerance (the high dilution factor within the OPI significantly reduced the ionization suppression, allowing the direct analysis of some complex matrices and reducing the efforts in sample preparation and method development).

### SUMMARY

In one aspect, the technology relates to a method of processing a sample plate containing a plurality of samples, the method includes: aspirating simultaneously, from the sample plate, a first sample droplet from a first sample of the plurality of samples with a first pipette and a second sample droplet from a second sample of the plurality of samples with a second pipette; and dispensing sequentially, from the first pipette and the second pipette, the first sample drop and the second sample drop into an open port interface (OPI). In an example, each of the first sample droplet and the second sample droplet includes a volume of about 1 nanoliter. In another example, the sample plate includes a multi-well plate, wherein each of the first sample droplet and the second sample droplet are aspirated simultaneously from different wells of the multi-well plate. In yet another example, dispensing sequentially the first sample droplet and the second sample droplet to the OPI includes: positioning the first pipette adjacent the OPI; dispensing the first sample droplet to the OPI; translating the first pipette and the second pipette simultaneously such that the second pipette is positioned adjacent the OPI; and dispensing the second sample droplet to the OPI. In still another example, the method further includes subsequent to aspirating simultaneously the first sample droplet and the second sample droplet, translating the first pipette and the second pipette simultaneously to a vicinity of the OPI.

In another example of the above aspect, the method further includes prior to aspirating simultaneously the first sample droplet and the second sample droplet, obtaining, from a receptacle, a first disposable tip for the first pipette and a second disposable tip for the second pipette. In an example, obtaining the first disposable tip and the second disposable tip are performed substantially simultaneously. In another example, the method further includes subsequent to dispensing the second sample droplet, releasing a disposable tip from each of the first pipette and the second pipette

In another aspect, the technology relates to a system for processing a sample plate, the system includes: a controller; a sample stage for receiving the sample plate; an open port interface (OPI) disposed remote from the sample stage; an ionization source fluidically coupled to the OPI; a pipette system includes a plurality of discrete pipettes; and a pipette system robot coupled to the controller for moving the pipette system in a simultaneous aspiration process and a sequential translating deposition process. In an example, the pipette system robot moves the pipette system in the simultaneous aspiration process adjacent the sample stage and in the sequential translating deposition process adjacent the OPI. In another example, the pipette system includes a pressure source and wherein each of the plurality of discrete pipettes are selectively coupled to the pressure source with a valve coupled to the controller. In yet another example, the simultaneous aspiration process includes simultaneously aspirating a plurality of samples with the plurality of discrete pipettes from the sample plate disposed on the sample stage and wherein the sequential translating deposition process includes sequentially depositing each of the plurality of aspirated samples from the plurality of discrete pipettes to the OPI. In still another example, the pipette system includes a plurality of pipette systems and wherein the pipette system robot includes a plurality of pipette system robots, wherein each of the plurality of pipette system robots moves one of the plurality of pipette systems.

In another example of the above aspect, the sample stage and the OPI are fixed relative to the pipette system and pipette system robot. In an example, the OPI is secured to the ionization source. In another example, the ionization source is fluidically coupled to the OPI with a fluid transfer conduit having a length of less than about 40 mm. In yet another example, the ionization source is fluidically coupled to the OPI with a fluid transfer conduit having a length of less than about 20 mm. In still another example, the ionization source is fluidically coupled to the OPI with a fluid transfer conduit having a length of less than about 10 mm.

In another example of the above aspect, the system further includes a pipette tip repository and a pipette tip disposal.

In another aspect, the technology relates to a method of depositing a plurality of sample drops into an open port interface (OPI), the method includes: simultaneously translating a plurality of discrete sample sources above the OPI; and sequentially gravitationally depositing the plurality of sample drops from the plurality of discrete sample sources into the OPI. In an example, the plurality of discrete sample sources includes a plurality of discrete pipettes fluidically coupled to a pipette system. In another example, the plurality of discrete sources includes a plurality of discrete sample wells of a well plate, and wherein sequentially gravitationally depositing the plurality of sample droplets includes forcing each of the plurality of sample droplets through an opening in a bottom of each of the discrete sample wells via a pressure pulse. In yet another example, sequentially gravitationally depositing the plurality of sample droplets includes applying a pressure pulse to the sample droplet with at least one of a syringe pump and a piezoelectric device.

### BRIEF DESCRIPTION OF THE DRAWINGS

FIG. 1 is a schematic view of an example system combining an open port interface (OPI) sampling interface and electrospray ionization (ESI) source.

FIG. 2 depicts a perspective view of an example of a microplate.

FIG. 3 depicts a system for simultaneous sampling and sequential gravitational deposition of a plurality of sample droplets.

FIGS. 3A-3D depicts a method for simultaneous sampling and sequential gravitational deposition of a plurality of sample droplets utilizing the system of FIG. 3.

FIGS. 4A-4G depicts another method for simultaneous sampling and sequential gravitational deposition of a plurality of sample droplets utilizing the system of FIG. 3.

FIG. 5 depicts a method of processing a sample plate containing a plurality of samples.

FIG. 6 depicts an example of a suitable operating environment in which one or more of the present examples can be implemented.

### DETAILED DESCRIPTION

Existing technologies allow for disposition of a small droplets of samples into an open port interface (OPI). In one example, a system utilizes a controlled gas pressure pulse to generate nano-liter sized sample droplets from the bottom of a microplates (iDOT-OPI: Bioanalysis, 2017, 9(21) 1667-1679). Although such a system enables a “upward-facing” configuration of the OPI for droplet capture, a special sample plate type with a precisely designed hole at the bottom is required. The size of the hole is also solvent dependent. Another example system utilizes a modified PAL system (as manufactured by CTC Analytics AG) for micro-liter sized droplet sampling (Anal. Chem. 2017, 89, 12578-12586). One limitation of this technology is that it cannot be used to dispense nanoliter sized samples. In addition, the throughput is lower than desirable due to the mechanical movement of a single sampling pipette utilized in the system.

The technologies described herein utilize a system to transfer multiple samples from individual wells of a microplate and introduce them to the OPI-MS as the format of low-volume (nanoliter to microliter) sample droplets for high-throughput analysis. Such a technology may utilize a droplet sampling system such as manufactured by BioDot, and in conjunction with standard microplates (those lacking the bottom opening in the well as described above). The system may utilize multi-channel tips to aspirate low-volume sample droplets from individual wells of standard microplates, and then accurately dispense those sample droplets to either a single OPI or multiple destination locations with high speed and volume control accuracy. The dispensing volume could be controlled from the nanoliter to microliter range. Two or more pipettes may be used to simultaneously obtain samples from a microplate, then sequentially deposit droplets into an OPI. In examples, the number of pipettes used may correspond to the number of wells in a row or column of a microplate.

As such, the sample aspiration into the tips is simultaneous, and the droplet dispensing from each tip is sequential to the same target OPI. In an example, the aspiration process may in the contact manner while the dispensing process may be non-contact. In another example, a multi-robot system could be utilized where each robot drives a sampling device of multiple pipettes. Such a system would contemplate a first sampling device performing a sequential dispensing operation substantially simultaneously with a second sampling device performing a sample aspiration process. Yet a third sampling device could be performing a washing/drying process (e.g., if the pipette tips are not consumable).

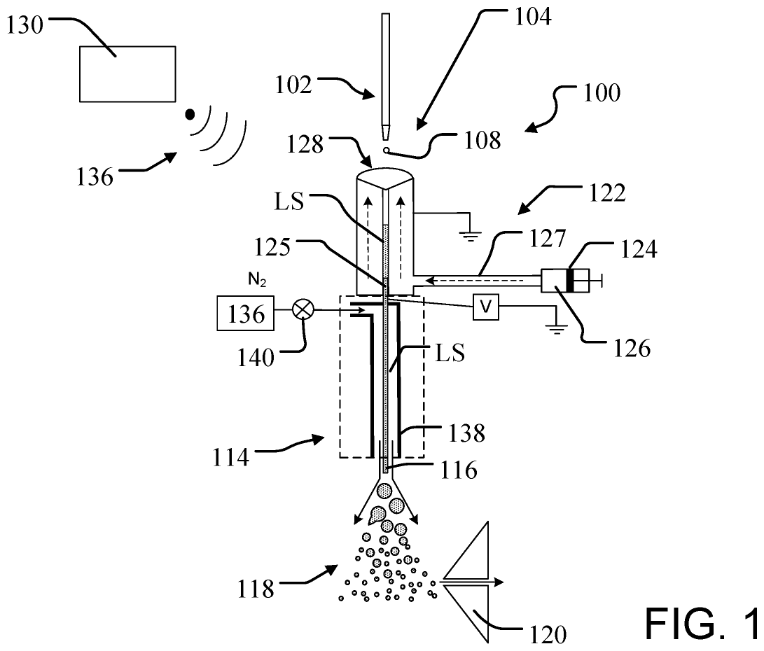

FIG. 1 is a schematic view of an example system 100 combining an OPI sampling interface 104 and ESI source 114. The system 100 may be a mass analysis instrument such as a mass spectrometry device that is for ionizing and mass-analyzing analytes received within an open end of a sampling OPI 104, e.g., at liquid boundary 128. Certain components of such a system 100 is described, for example, in U.S. Pat. No. 10,770,277, the disclosure of which is incorporated by reference herein in its entirety. A sampling pipette 102 releases a droplet 108 into the open end of sampling OPI 104. As shown in FIG. 1, the example system 100 generally includes the sampling OPI 104 in liquid communication with the ESI source 114 for discharging a liquid containing one or more sample analytes (e.g., via electrospray electrode 116) into an ionization chamber 118, and a mass analyzer detector (depicted generally at 120) in communication with the ionization chamber 118 for downstream processing and/or detection of ions generated by the ESI source 114. Due to the configuration of the nebulizer probe 138 and electrospray electrode 116 of the ESI source 114, samples ejected therefrom are transformed into the gas phase. A liquid handling system 122 (e.g., including one or more pumps 124 and one or more conduits 125) provides for the flow of liquid from a solvent reservoir 126 to the sampling OPI 104 and from the sampling OPI 104 to the ESI source 114. The solvent reservoir 126 (e.g., containing a liquid, desorption solvent) can be liquidly coupled to the sampling OPI 104 via a supply conduit 127 through which the liquid can be delivered at a selected volumetric rate by the pump 124 (e.g., a reciprocating pump, a positive displacement pump such as a rotary, gear, plunger, piston, peristaltic, diaphragm pump, or other pump such as a gravity, impulse, pneumatic, electrokinetic, and centrifugal pump, all by way of non-limiting example). As discussed in detail below, the flow of liquid into and out of the sampling OPI 104 occurs within a sample space accessible at the open end such that one or more droplets 108 can be introduced into the liquid boundary 128 at the sample tip and subsequently delivered to the ESI source 114. A controller 130 can be operatively coupled to the various components, such as the pump 124 to control fluid flow to the OPI 104, the mass detector analyzer 120, and other components. Controller 130 can be, but is not limited to, a microcontroller, a computer, a microprocessor, or any device capable of sending and receiving control signals and data. Wired or wireless 136 connections between the controller 130 and the remaining elements of the system 100 are not depicted but would be apparent to a person of skill in the art.

The ESI source 114 can include a source 136 of pressurized gas (e.g., nitrogen, air, or a noble gas) that supplies a high velocity nebulizing gas flow to the nebulizer probe 138 that surrounds the outlet end of the electrospray electrode 116. As depicted, the electrospray electrode 116 protrudes from a distal end of the nebulizer probe 138. The pressurized gas interacts with the liquid discharged from the electrospray electrode 116 to enhance the formation of the sample plume and the ion release within the plume for sampling by mass analyzer detector 120, e.g., via the interaction of the high-speed nebulizing flow and jet of liquid sample (e.g., analyte-solvent dilution). The liquid discharged may include discrete volumes of liquid samples LS received from the pipette 102. The volumes of liquid samples LS are diluted as they are transported from the OPI 104 to the ESI source 114, the solvent may also be referred to herein as a transport liquid. In examples, the sample may be diluted up to about 500×, 750×, 1000×, or more. The nebulizer gas can be supplied at a variety of flow rates, for example, in a range from about 0.1 L/min to about 20 L/min, which can also be controlled by the controller 130 (e.g., via opening and/or closing valve 140).

In FIG. 1, the OPI 104 is upwardly-facing and fluidically coupled to the ESI source 114 such that the fluid transfer conduit 125, through which the liquid samples flow, is shortened, relative to a configuration where the OPI 104 faces downward. In examples, the fluid transfer conduit 125 may have a length of less than about 40 mm, less than about 20 mm, or less than about 10 mm. The shortened length of the fluid transfer conduit 125 results in certain benefits, prior to being discharged via the ESI source 114. One benefit would be less flow resistance as compared to a system that include a longer transfer liquid conduit 125. Thus, a higher solvent flowrate could be archived. Considering the same dilution factor (e.g., the same volume of the diluted sample plug), it would take less time to flush the sample through the ESI. As such, in the MS chronogram, the signal duration (as characterized for example by peak width) would be shorter, allowing the higher analytical throughput and higher peak height (e.g., a high S/N ratio).

It will be appreciated that the flow rate of the nebulizer gas can be adjusted (e.g., under the influence of controller 130) such that the flow rate of liquid within the sampling OPI 104 can be adjusted based on, for example, suction/aspiration force generated by the interaction of the nebulizer gas and the analyte-solvent dilution as it is being discharged from the electrospray electrode 116 (e.g., due to the Venturi effect). The ionization chamber 118 can be maintained at atmospheric pressure, though in some examples, the ionization chamber 118 can be evacuated to a pressure lower than atmospheric pressure.

It will also be appreciated by a person skilled in the art and in light of the teachings herein that the mass analyzer detector 120 can have a variety of configurations. Generally, the mass analyzer detector 120 is configured to process (e.g., filter, sort, dissociate, detect, etc.) sample ions generated by the ESI source 114. By way of non-limiting example, the mass analyzer detector 120 can be a triple quadrupole mass spectrometer, or any other mass analyzer known in the art and modified in accordance with the teachings herein. Other non-limiting, exemplary mass spectrometer systems that can be modified in accordance with various aspects of the systems, devices, and methods disclosed herein can be found, for example, in an article entitled “Product ion scanning using a Q-q-Q linear ion trap (Q TRAP) mass spectrometer,” authored by James W. Hager and J. C. Yves Le Blanc and published in Rapid Communications in Mass Spectrometry (2003; 17: 1056-1064); and U.S. Pat. No. 7,923,681, entitled “Collision Cell for Mass Spectrometer,” the disclosures of which are hereby incorporated by reference herein in their entireties.

Other configurations, including but not limited to those described herein and others known to those skilled in the art, can also be utilized in conjunction with the systems, devices, and methods disclosed herein. For instance, other suitable mass spectrometers include single quadrupole, triple quadrupole, ToF, trap, and hybrid analyzers. It will further be appreciated that any number of additional elements can be included in the system 100 including, for example, an ion mobility spectrometer (e.g., a differential mobility spectrometer) that is disposed between the ionization chamber 118 and the mass analyzer detector 120 and is configured to separate ions based on their mobility difference between in high-field and low-field). Additionally, it will be appreciated that the mass analyzer detector 120 can comprise a detector that can detect the ions that pass through the analyzer detector 120 and can, for example, supply a signal indicative of the number of ions per second that are detected.

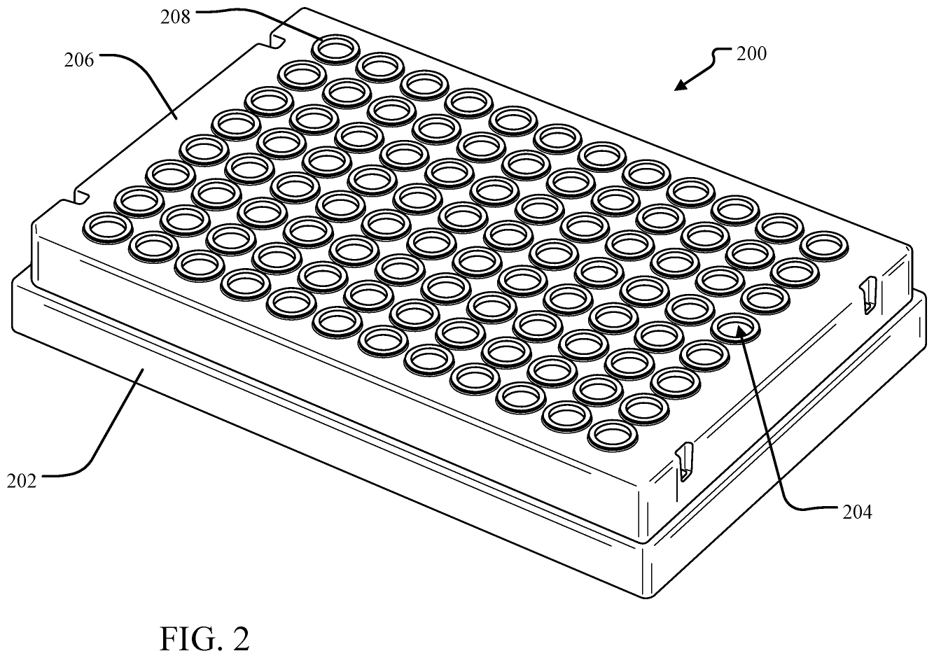

FIG. 2 is a perspective view of an example microplate or well plate 200. The well plate 200 includes a base or rim 202 and a plurality of wells 204 arranged in a number of rows and columns. In examples, the wells 204 may be integrally formed with a body 206 that surrounds the plurality of wells 204, and the body 206 may be integrally formed with the base or rim 202. The base 202 may also be referred to as a skirt and may have outer dimensions generally similar to, or wider than, those of the body 206. In general, the wells 204 may have an open mouth defined by an outer raised rim 208 and may be generally cylindrical or conical in shape. In other examples, the walls of the wells 204 may be straight and the base of each well 204 may be curved, concave, or flat. Different configurations and form factors of wells 204 are known in the art; particular configurations or form factors are not necessarily relevant to the present technology.

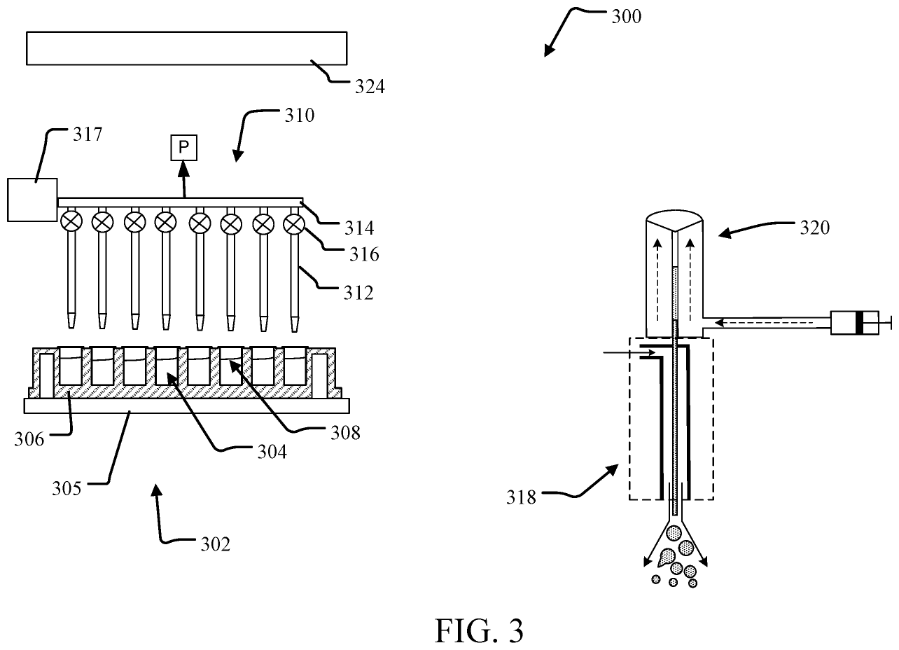

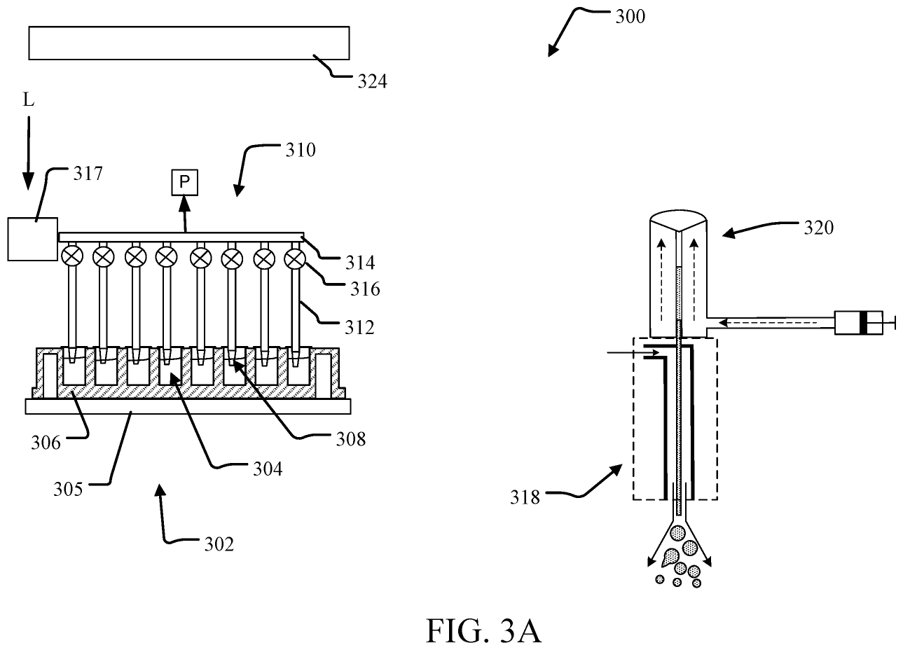

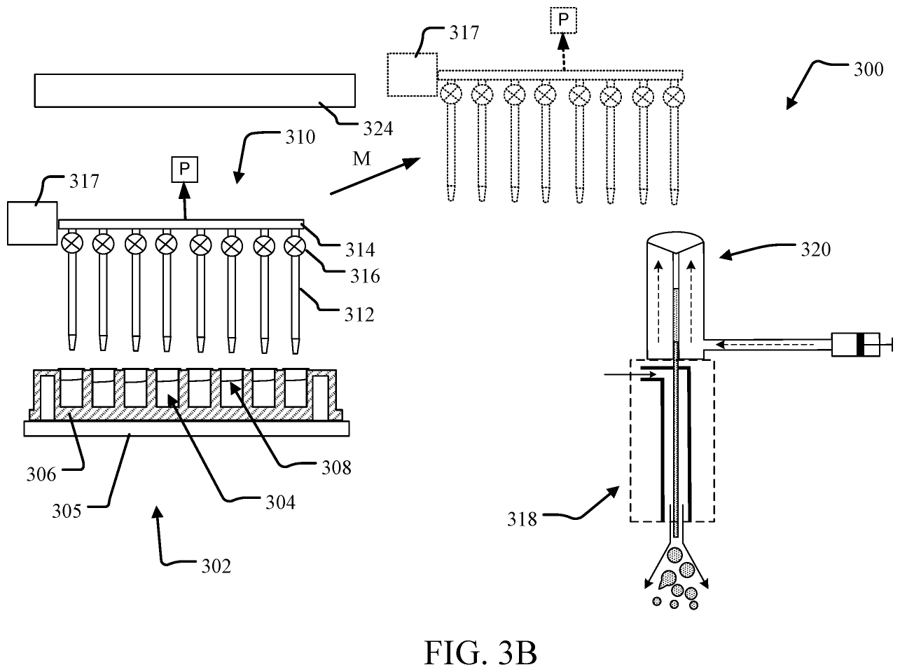

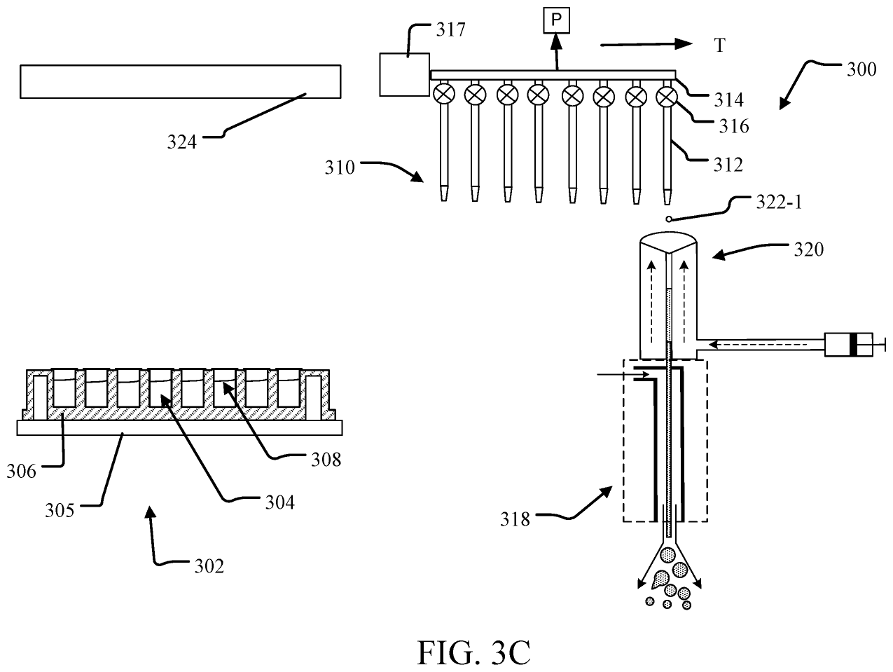

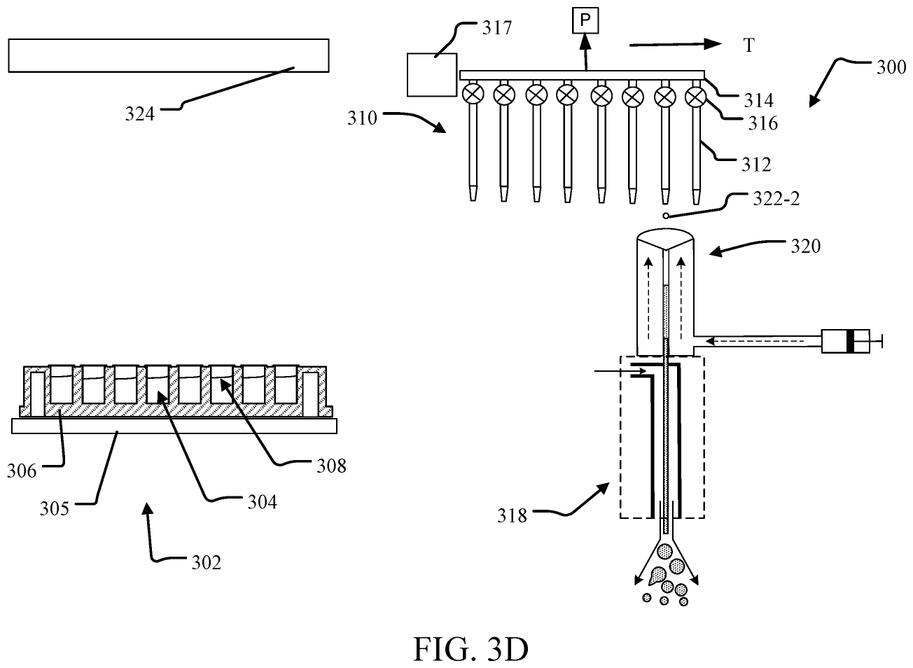

FIG. 3 depicts a system 300 for simultaneous sampling and sequential gravitational deposition of a plurality of sample droplets. The system 300 aspirates sample droplets from a well plate 302 that includes a base 302 and a body 306 that defines a plurality of wells 304, such as described herein. The well plate 302 may be supported on a sample stage 305 that in examples is fixed in place, but in other examples may be moveable. Each well 304 contains a sample, as depicted by sample liquid line 308. The sample droplets are aspirated from wells 304 of the well plate 302 by a sampling device 310 that includes a plurality of parallel pipettes 312 selectively coupled to a manifold 314 via a plurality of valves 316. The manifold 314 is fluidically coupled to a pressure source P, that can apply both negative and positive pressure to each pipette 312 when a particular valve 316 is opened. A sampling device robot (depicted schematically as 317) may move the sampling device 310 in the various directions and processes described herein. Movement of the sampling device robot 317 may obviate the need for a moveable stage 306, but systems utilizing one or more sampling device robots 317 in conjunction with a moveable stage may be particularly useful. For example, a moveable stage may be utilized to advance a well plate into a location where pipetting operations may be performed.

In the depicted example, the number of pipettes 312 on the sampling device 310 is equal to the number of wells 304 in the well plate 302, though a greater or fewer number of pipettes may be utilized, since each valve 316 is individually controlled. As described below, the system 300 also includes an ionization device 318 such as the ESI source described in the context of FIG. 1, or some other type of ionization device, as described elsewhere herein or known in the art. The ESI source 318 is closely coupled to an OPI 320, as described in FIG. 1. Here, the OPI 320 is upward facing, so as to receive sample droplets from above, via the sampling device 310, as described below. Further the system 300 may include one or more auxiliary stations 324. Auxiliary stations 324 may include a wash station (e.g., if the pipettes 312 are reused between aspirating samples from different wells). In another example, the auxiliary station 324 may include a tip disposable station, where disposable tips of the pipettes 312 may be deposited after use. If a tip disposal station is used, a tip application station may also be used, so new tips may be applied to each pipette 312 before another sample is aspirated from the well plate 302.

FIGS. 3A-3D depicts a method for simultaneous sampling and sequential gravitational deposition of a plurality of sample droplets utilizing the system 300 of FIG. 3. The components of the system 300 that perform the various operations are described in the context of FIG. 3 and, as such, are not necessarily described further. In FIG. 3A, the sampling device 310 is lowered L from the position depicted in FIG. 3 to the aspirating position depicted in FIG. 3A, where a tip of each pipette 312 is at or below the level of the sample 308, such that a volume of the sample 308 may be aspirated from each sample well 304. In this position, one or more of the valves 316 are opened and a negative pressure is applied from the pressure source P so as to aspirate at least a portion of a volume of the sample 308 from a well 304. In examples, all of the valves 316 may be opened such that simultaneous aspiration from each of the wells 304 may be performed. Fewer than all of the valves 316 may be opened in other examples. In examples, the amount aspirated from each well 304 may be greater than or equal to a volume of the droplet ultimately delivered to the OPI 320. Thereafter, once the desired values of each sample 308 are aspirated, the aspiration device 310 is removed from the vicinity of the well plate 302 and moved M to a vicinity of the OPI 320, as depicted in FIG. 3B.

FIG. 3C depicts a first pipette 312 gravitationally depositing a first droplet 322-1 into the OPI 320. Thereafter, the sampling device translates T to the position depicted in FIG. 3D, where a droplet 322-2 is gravitationally deposited from a second pipette into the OPI 320. This process of translating T simultaneously the pipettes 312 of the sampling device 310 and depositing of a droplet 322 is continued alternately until droplets from each pipette 312 are discretely deposited into the OPI 320. As each pipette 312 is positioned above the OPI 320, the associated valve 316 opens and a positive pressure may be applied by the pressure source P so as to release a droplet 322 into the OPI 320. In other examples, opening the associated valve 316 without applying a positive pressure may be sufficient for a droplet 322 to exit the pipette 312. Subsequent to release of the final droplet 322 from the last pipette 312, the sampling device robot 317 may move the sampling device 310 to one or more auxiliary stations 324 for further processing.

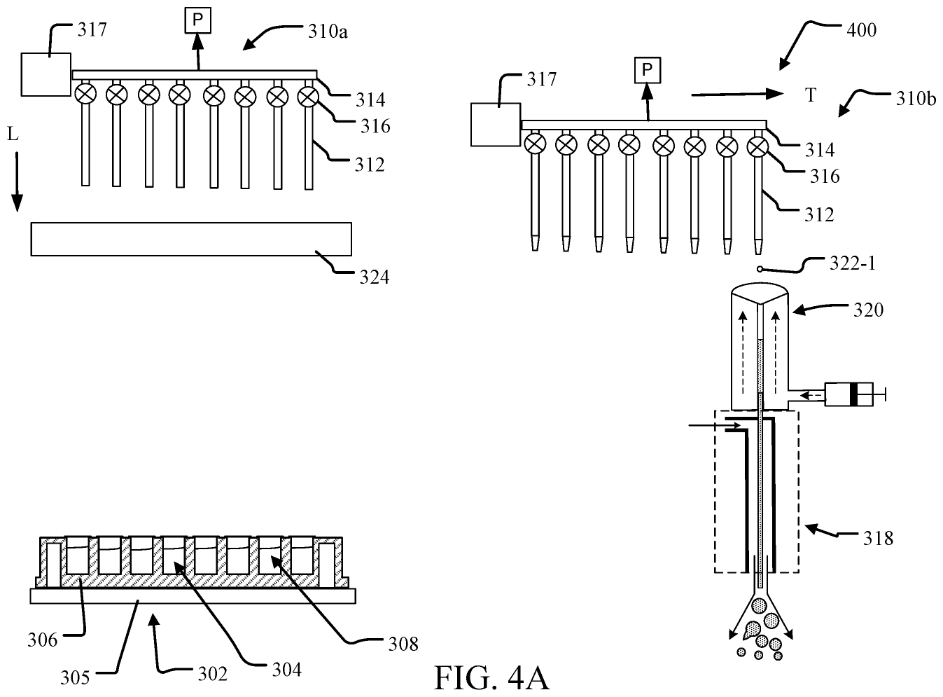

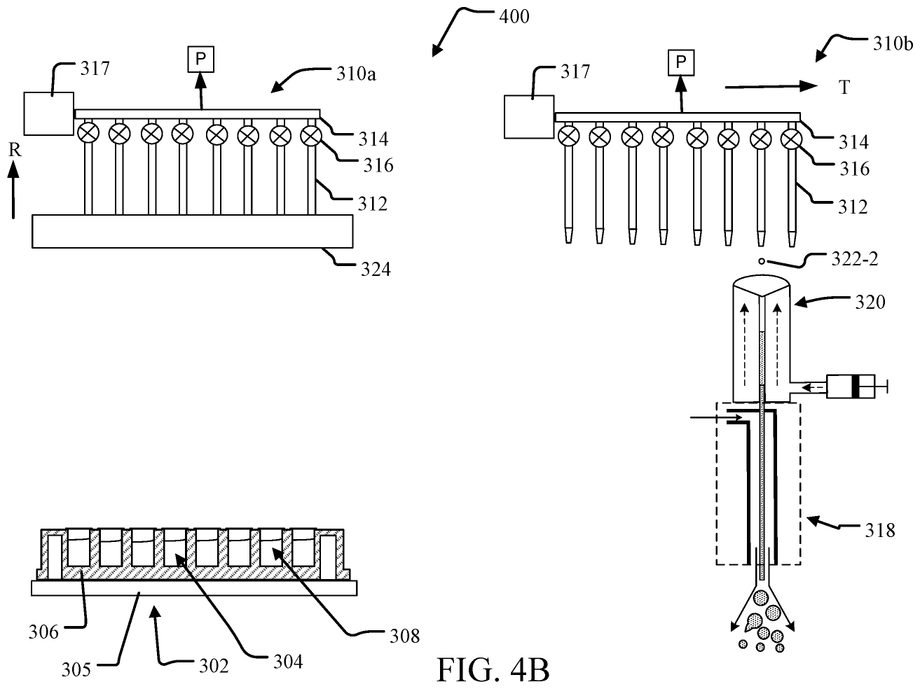

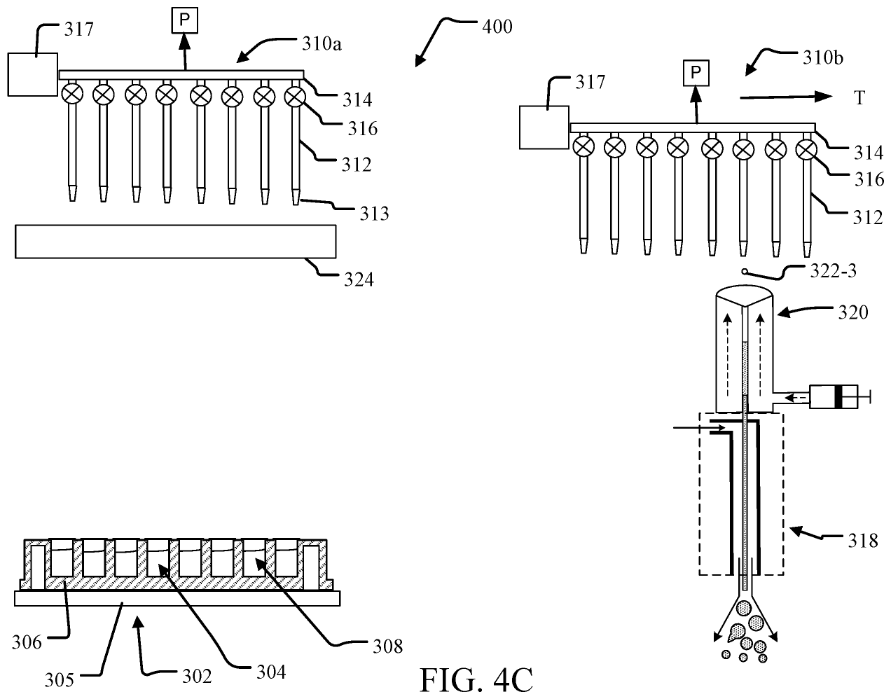

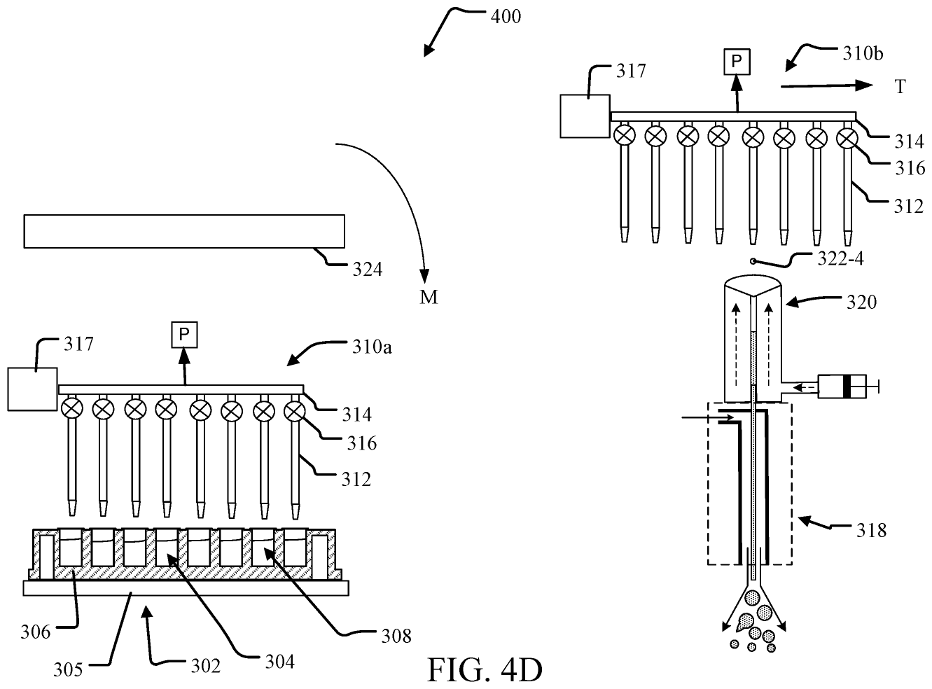

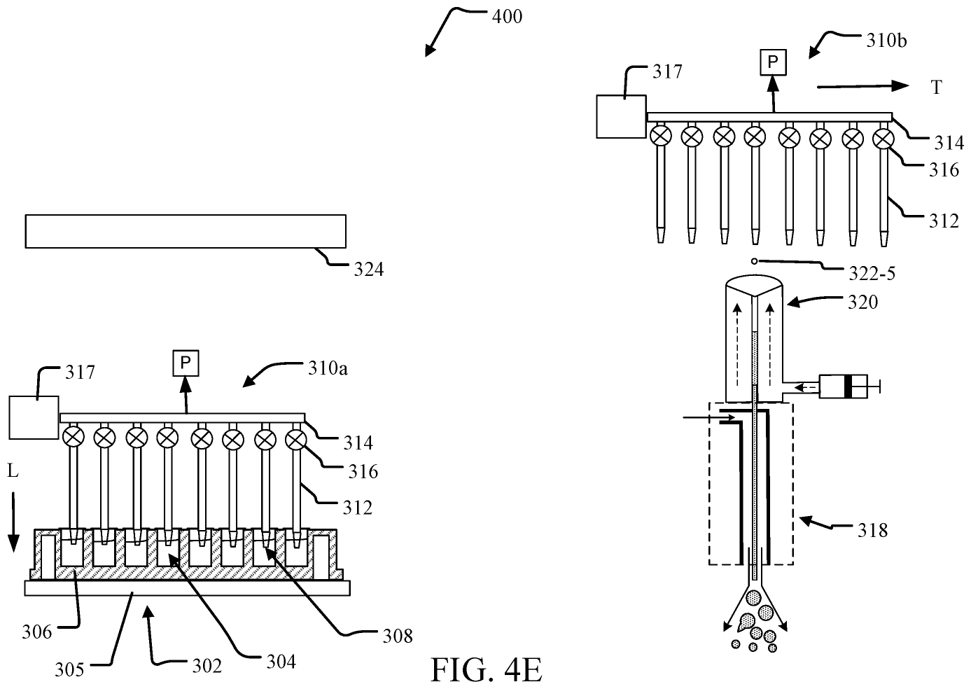

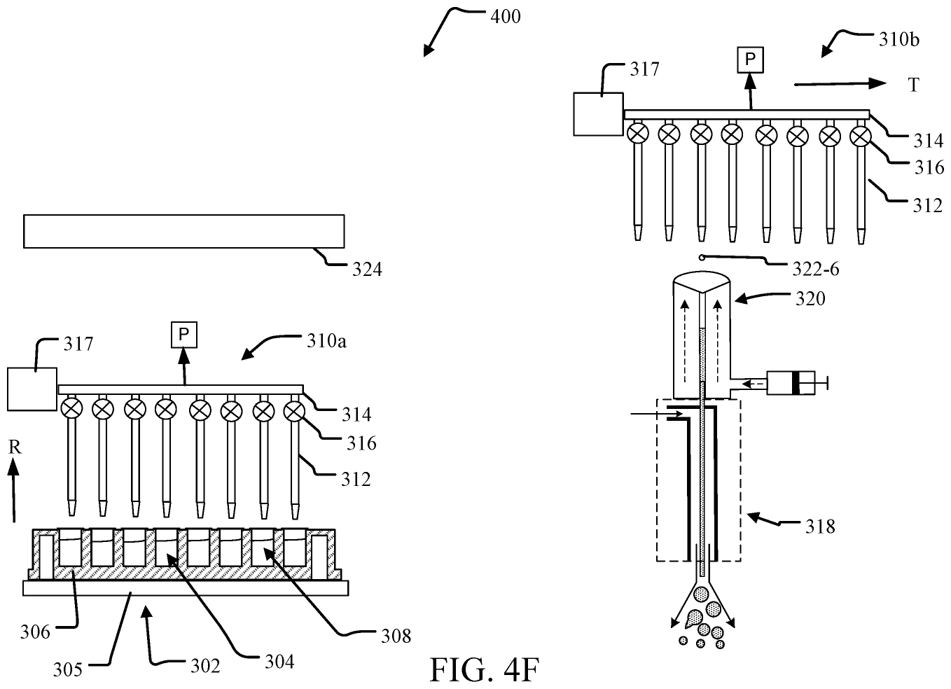

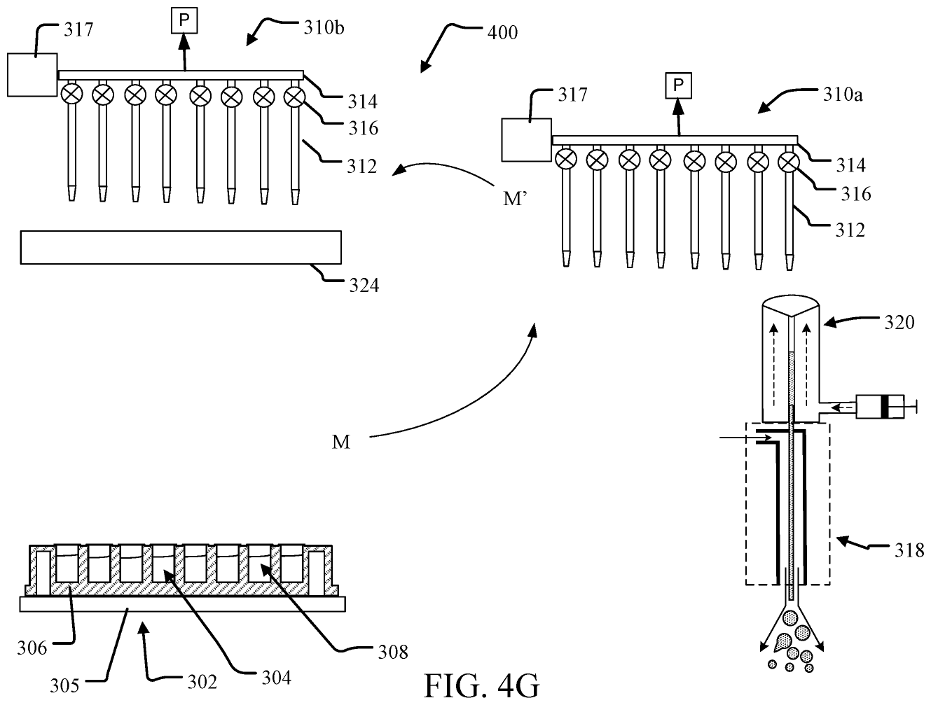

FIGS. 4A-4G depicts another example system 400, based on the system 300 of FIG. 3, as well as a method for simultaneous sampling and sequential gravitational deposition of a plurality of sample droplets therewith. The components of the system 400 that perform the various operations are described in the context of FIG. 3 and, as such, are not necessarily described further. The system 400 includes, in this case, a fixed sample stage 305 for receiving a well plate 302, an OPI 320 coupled to an ESI source 318, an auxiliary station 324 in the form of a pipette tip station, and two sampling devices 310a, 310b, each having its own sampling device robot 317, pressure source P, pipettes 312, etc. It should be noted that no sampling device is disposed adjacent the well plate 302 in FIG. 4A at the start of the method, though in another example, a third sampling device may be disposed adjacent the well plate 302 in FIG. 4A. At the start of the method, the first sampling device 310a is positioned proximate the pipette tip station 324, preparing for each of the pipettes 312 to simultaneously be loaded with a tip therefrom. Proximate the OPI 320, the second sampling device 310b has gravitationally deposited a first droplet 322-1 into the OPI 320, as described elsewhere herein. Thereafter, the first sampling device 310a is lowered towards the pipette tip dispenser 324, while the second sampling device 310b translates T so as to align a second pipette 312 with the OPI 320. Both of these conditions are depicted in FIG. 4B.

Once the pipette 312 are disposed in the pipette tip station 324, the first sampling device 310a may be raised R therefrom. In FIG. 4B, the second sampling device gravitationally deposits a second droplet 322-2 into the OPI 320, after which it translates again to align a different pipette 312 with the OPI 320. In FIG. 4C, the pipettes 312 of the first sampling device 310a are removed from the pipette tip station 324, with each having a disposable pipette tip 313 now secured thereto. Further, the translation T of the second sampling deice 310b continues, and a third droplet 322-3 is gravitationally dropped from a third pipette 312 into the OPI 320.

In FIG. 4D, the first sampling device 310a has moved M to a position adjacent the well plate 302 resting on the sample stage 305. Translational T movement of the second sampling device 310b continues, and a fourth droplet 322-4 is gravitationally deposited into the OPI 320 from a fourth pipette 312 of the second sampling device 310b. In FIG. 4E, the first sampling device 310a is lowered L such that the pipettes 312 are positioned in the wells 304 so as to draw a portion of the sample 308 into the pipette tips 313. At the OPI 320, the second sampling device 310b releases a fifth droplet 322-5, followed by another translational T movement. In FIG. 4F, the first sampling device 310a is raised R so as to remove the pipette tips 313 from the sample wells 304. At the second sampling device 310b, yet another droplet 322-6 is released therefrom into the OPI 320. In FIG. 4G, the second sampling device 310b is moved M′ to the pipette tip station 324, where the process to release used tips 313 and secure new tips 313 will take place. The first sampling device 310a has moved M to a position in proximity to the OPI 320, so as to begin its own sequential gravitational deposition process.

Although the examples above depict comparatively mobile sampling devices (e.g., as compared to the OPI and sample stage) other example systems contemplate a completely fixed sampling device, used in conjunction with a movable OPI and a movable sample stage. In other examples, the sampling device may be partially mobile (e.g., may move only in a vertical direction to draw samples from a sample plate), along with a mobile OPI and mobile sample stage. In general, the technologies described herein contemplate systems where the sampling device, OPI, and sample stage are movable relative to each other, regardless of a particular configuration.

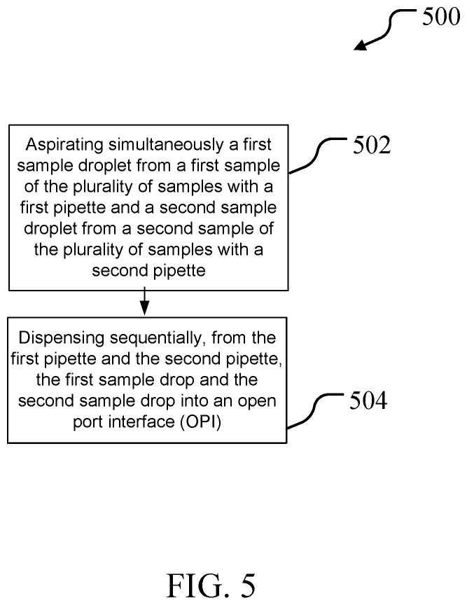

FIG. 5 depicts a method 500 of processing a sample plate containing a plurality of samples. The sample plate may be a standard well plate, such as depicted for example in FIGS. 2-4G where each well of the well plate contains a sample. The method 500 may begin with operation 502, which includes aspirating simultaneously, from the sample plate, a first sample droplet from a first sample with a first pipette and a second sample droplet from a second sample with a second pipette. Each sample is contained within a discrete well of the sample plate. In examples, more than two sample droplets from more than two sample wells may be simultaneously aspirated. In certain examples, the number of pipettes may be equal to a number of wells in a row or column of a sample plate. Dispensing devices such as those described herein, where multiple pipettes are operably coupled to each other, are contemplated. In such examples, a number of valves may control aspiration into each of the pipettes.

Operation 504 includes dispensing sequentially, from the first pipette and the second pipette, the first sample drop and the second sample drop into an open port interface (OPI). In examples, the droplets may be measured in nanoliters (nL), picoliters (pL), or other small volumes. In examples, the sample droplets may have a volume of about 1-20 nL, 1-5 nL, 5-10 nL, 10-15 nL, or about 15-20 nL. In other examples, the droplet size may be about 1 nL, 2 nL, 3 nL, 4 nL, 5 nL, 6 nL, 7 nL, 8 nL, 9 nL, 10 nL, or more, up to 20 nL. Sequential dispensing refers to a process where a plurality of discrete sample vessels (such as pipettes) are simultaneously moved together such that each vessel is substantially aligned with an OPI. Once a particular pipette is aligned, the associated valve is opened aligned, the valve (and in examples, a pressure source is activated) so as to gravitationally dispense a droplet from the pipette into the OPI. In a more specific example, sequential dispensing of the sample droplets may include positioning the first pipette adjacent the OPI, then dispensing the first sample droplet to the OPI. Once the first sample droplet is released, the first pipette, second pipette (and any additional pipettes) are simultaneously translated until the second pipette is positioned adjacent the OPI, after which, the second sample droplet is deposited to the OPI. This process of translating and depositing, translating and depositing, and so on continues until all desired sample droplets have been deposited.

Other operations of the method 500 are contemplated, depending on the particular configuration of the system that performs the method 500. In example systems, a sample stage may be disposed remote from the OPI, thus requiring, subsequent to aspirating the sample droplets, moving the first pipette and the second pipette simultaneously to a vicinity or proximity of the OPI. The method 500 described herein may be practiced with reusable pipettes (which may be washed between cycles) or pipettes with disposable tips (into which sample droplets are aspirated). As such the method 500 may include, prior to aspirating simultaneously the first sample and the second sample, obtaining, from a receptacle, a first disposable tip for the first pipette and a second disposable tip for the second pipette. The tip receptacle may be configured such that the disposable tips may be obtained substantially simultaneously. Once used, the method 500 contemplates releasing a used disposable tip from each of the pipettes; this may also be performed simultaneously.

The systems described herein utilizing one or more robot-actuated sampling device(s) and an OPI closely-coupled to an ESI can achieve very high sampling rates leading to improved sampling frequencies for a well plate. Sampling frequency corresponds to the amount of time required to perform an analysis of a particular sample, as measured from a time a process begins (e.g., when, before a sample is aspirated, a disposable pipette tip is attached to a pipette) to the time a process ends (e.g., when, subsequent to delivering the sample to an OPI, the disposable pipette tip is released from the pipette). Other start and end points for a sampling process are contemplated and understood in the art. The sampling frequencies may vary as required or desired for a particular application. For example, with the systems described herein, a sample-to-sample frequency may be less than about 10 seconds/sample, less than about 5 seconds/sample, and less than about 1 second/sample. This contemplates a system that utilizes simultaneous aspiration and sequential gravitational deposition to an OPI.

Improved sampling rates from the same sample (e.g., the same well of a well plate), across various known modes. In a continuous infusion mode, discrete ejections may be closely spaced together so as to achieve constant or near constant sample delivery to the ESI and a corresponding continuous MS signal at the detector. In examples, this could last for seconds or minutes, depending upon the application (e.g., 5-20 Hz at 5 nL volumes). In another example, discrete small volume may be ejected at a high rate to create the effect of a larger volume of sample introduced into the OPI (e.g., greater than about 20 Hz, where the frequency is dependent upon the sample ejection volume for the system. Systems such as those described herein that use pipetting are contemplated to accurately vary sample volume in a small range, or to vary individual ejection volumes over a large range and retain high speed capability. In another example, the same sample (e.g., from a single well) may be subject to discrete sampling events. In such an example, the pipette may stay in position and provide multiple spaced ejections to create multiple MS peaks at the detector (e.g., an individual pipette may deliver multiple samples prior to the sampling device translating to a subsequent pipette).

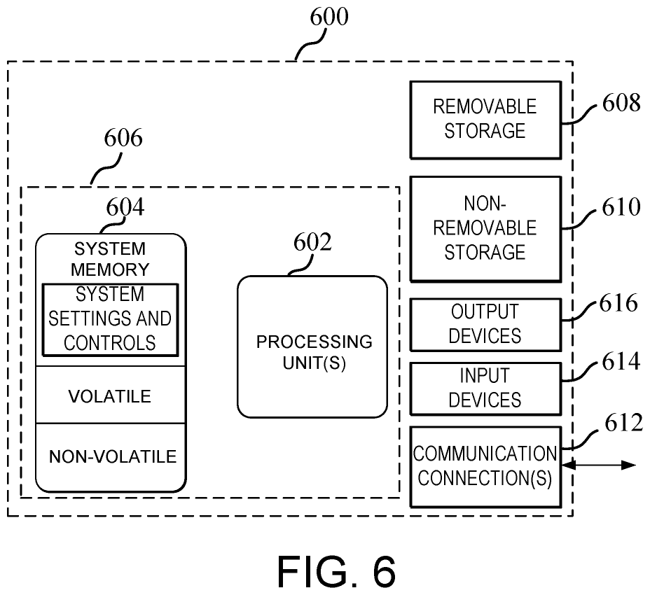

FIG. 6 depicts one example of a suitable operating environment 600 in which one or more of the present examples can be implemented. This operating environment may be incorporated directly into the controller for a mass spectrometry system, e.g., such as the controller depicted in FIG. 1. This is only one example of a suitable operating environment and is not intended to suggest any limitation as to the scope of use or functionality. Other well-known computing systems, environments, and/or configurations that can be suitable for use include, but are not limited to, personal computers, server computers, hand-held or laptop devices, multiprocessor systems, microprocessor-based systems, programmable consumer electronics such as smart phones, network PCs, minicomputers, mainframe computers, tablets, distributed computing environments that include any of the above systems or devices, and the like. In view of the portability of the processing systems described herein, a laptop or tablet computer may be desirably connected via a wired or wireless connection to a controller such as depicted in FIG. 1, and may send the appropriate control signals before, during, and after an electrode position-setting event, so as to control operation of the various components of the system.

In its most basic configuration, operating environment 600 typically includes at least one processing unit 602 and memory 604. Depending on the exact configuration and type of computing device, memory 604 (storing, among other things, instructions to control the sampling device robot, valves, gas source, etc., or perform other methods disclosed herein) can be volatile (such as RAM), non-volatile (such as ROM, flash memory, etc.), or some combination of the two. This most basic configuration is illustrated in FIG. 6 by dashed line 606. Further, environment 600 can also include storage devices (removable, 608, and/or non-removable, 610) including, but not limited to, magnetic or optical disks or tape. Similarly, environment 600 can also have input device(s) 614 such as touch screens, keyboard, mouse, pen, voice input, etc., and/or output device(s) 616 such as a display, speakers, printer, etc. Also included in the environment can be one or more communication connections 612, such as LAN, WAN, point to point, Bluetooth, RF, etc.

Operating environment 600 typically includes at least some form of computer readable media. Computer readable media can be any available media that can be accessed by processing unit 602 or other devices having the operating environment. By way of example, and not limitation, computer readable media can include computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, solid state storage, or any other tangible medium which can be used to store the desired information. Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media. A computer-readable device is a hardware device incorporating computer storage media.

The operating environment 600 can be a single computer operating in a networked environment using logical connections to one or more remote computers. The remote computer can be a personal computer, a server, a router, a network PC, a peer device or other common network node, and typically includes many or all of the elements described above as well as others not so mentioned. The logical connections can include any method supported by available communications media. Such networking environments are commonplace in offices, enterprise-wide computer networks, intranets and the Internet.

In some examples, the components described herein include such modules or instructions executable by computer system 600 that can be stored on computer storage medium and other tangible mediums and transmitted in communication media. Computer storage media includes volatile and non-volatile, removable and non-removable media implemented in any method or technology for storage of information such as computer readable instructions, data structures, program modules, or other data. Combinations of any of the above should also be included within the scope of readable media. In some examples, computer system 600 is part of a network that stores data in remote storage media for use by the computer system 600.

This disclosure described some examples of the present technology with reference to the accompanying drawings, in which only some of the possible examples were shown. Other aspects can, however, be embodied in many different forms and should not be construed as limited to the examples set forth herein. Rather, these examples were provided so that this disclosure was thorough and complete and fully conveyed the scope of the possible examples to those skilled in the art.

Although specific examples were described herein, the scope of the technology is not limited to those specific examples. One skilled in the art will recognize other examples or improvements that are within the scope of the present technology. Therefore, the specific structure, acts, or media are disclosed only as illustrative examples. Examples according to the technology may also combine elements or components of those that are disclosed in general but not expressly exemplified in combination, unless otherwise stated herein. The scope of the technology is defined by the following claims and any equivalents therein.

What is claimed is:

1. A method of processing a sample plate containing a plurality of samples, the method comprising:
aspirating simultaneously, from the sample plate, a first sample droplet from a first sample of the plurality of samples with a first pipette and a second sample droplet from a second sample of the plurality of samples with a second pipette; and
dispensing sequentially, from the first pipette and the second pipette, the first sample drop and the second sample drop into an open port interface (OPI).

2. The method of claim 1, wherein the sample plate comprises a multi-well plate, wherein each of the first sample droplet and the second sample droplet are aspirated simultaneously from different wells of the multi-well plate.

3. The method of claim 1, wherein dispensing sequentially the first sample droplet and the second sample droplet to the OPI comprises:
positioning the first pipette adjacent the OPI;
dispensing the first sample droplet to the OPI;
translating the first pipette and the second pipette simultaneously such that the second pipette is positioned adjacent the OPI; and
dispensing the second sample droplet to the OPI.

4. The method of claim 1, further comprising, subsequent to aspirating simultaneously the first sample droplet and the second sample droplet, translating the first pipette and the second pipette simultaneously to a vicinity of the OPI.

5. The method of claim 1, further comprising, prior to aspirating simultaneously the first sample droplet and the second sample droplet, obtaining, from a receptacle, a first disposable tip for the first pipette and a second disposable tip for the second pipette.

6. The method of claim 3, further comprising subsequent to dispensing the second sample droplet, releasing a disposable tip from each of the first pipette and the second pipette.

7. A system for processing a sample plate, the system comprising:
a controller;
a sample stage for receiving the sample plate;
an open port interface (OPI) disposed remote from the sample stage;
an ionization source fluidically coupled to the OPI;
a pipette system comprising a plurality of discrete pipettes; and
a pipette system robot coupled to the controller for moving the pipette system in a simultaneous aspiration process and a sequential translating deposition process.

8. The system of claim 7, wherein the pipette system robot moves the pipette system in the simultaneous aspiration process adjacent the sample stage and in the sequential translating deposition process adjacent the OPI.

9. The system of claim 7, wherein the pipette system comprises a pressure source and wherein each of the plurality of discrete pipettes are selectively coupled to the pressure source with a valve coupled to the controller.

10. The system of claim 7, wherein the simultaneous aspiration process comprises simultaneously aspirating a plurality of samples with the plurality of discrete pipettes from the sample plate disposed on the sample stage and wherein the sequential translating deposition process comprises sequentially depositing each of the plurality of aspirated samples from the plurality of discrete pipettes to the OPI.

11. The system of claim 7, wherein the pipette system comprises a plurality of pipette systems and wherein the pipette system robot comprises a plurality of pipette system robots, wherein each of the plurality of pipette system robots moves one of the plurality of pipette systems.

12. The system of claim 7, wherein the sample stage and the OPI are fixed relative to the pipette system and pipette system robot.

13. The system of claim 7, wherein the OPI is secured to the ionization source.

14. The system of claim 7, wherein the ionization source is fluidically coupled to the OPI with a fluid transfer conduit having a length of less than about 40 mm.

15. The system of claim 7, wherein the ionization source is fluidically coupled to the OPI with a fluid transfer conduit having a length of less than about 10 mm.

16. The system of claim 7, further comprising a pipette tip repository and a pipette tip disposal.

17. A method of depositing a plurality of sample drops into an open port interface (OPI), the method comprising:
simultaneously translating a plurality of discrete sample sources above the OPI; and
sequentially gravitationally depositing the plurality of sample drops from the plurality of discrete sample sources into the OPI.

18. The method of claim 17, wherein the plurality of discrete sample sources comprises a plurality of discrete pipettes fluidically coupled to a pipette system.

19. The method of claim 17, wherein the plurality of discrete sources comprises a plurality of discrete sample wells of a well plate, and wherein sequentially gravitationally depositing the plurality of sample droplets comprises forcing each of the plurality of sample droplets through an opening in a bottom of each of the discrete sample wells via a pressure pulse.

20. The method of claim 17, wherein sequentially gravitationally depositing the plurality of sample droplets comprises applying a pressure pulse to the sample droplet with at least one of a syringe pump and a piezoelectric device.
